(19) United States
(12) Patent Application Publication
(10) Pub. No.: US 2004/0135004 A1
(43) Pub. Date: Jul. 15, 2004

(54) Device for spraying liquid and brush cutter provided with said device

(76) Inventor: Stephane Fex, L'Ascension (CA)

Correspondence Address: OGILVY RENAULT, 1981 MCGILL COLLEGE AVENUE, SUITE 1600, MONTREAL, QC, H3A2Y3, CA

(21) Appl. No.: 10/638,474

(22) Filed: Aug. 12, 2003

(30) Foreign Application Priority Data
Oct. 23, 2002 (CA) 2,409,227

(51) Int. Cl. B05B 9/08

(52) U.S. Cl. 239/152

(57) ABSTRACT

A device for spraying a fluid, said device comprising a reservoir for the fluid to be sprayed; pumping means comprising a electric operated pump having an inlet port in fluid communication with the fluid of said reservoir and an outlet port; a tubing having opposite ends, one end being in fluid communication with the outlet port of the pump, the other end being in fluid communication with a spraying nozzle; electric power supply means; a on-off switch means; electrical wiring connecting the electric power supply means, the electric motor and the on-off switch means to have the electric motor remotely operated by the on-off switch; a harness means allowing a user to wear an assembly defined by the reservoir, the pumping means and the power supply means; and a valve means provided across the tubing to allow passage of said fluid when this latter is pressurized by the pump and to prevent the fluid to drip from the nozzle when not pressurized by the pump. The invention also relates to a brush cutter provided with said device.

### FIELD OF THE INVENTION

The invention relates to a device for spraying fluid, especially fluid products that can be pumped for the treatment of plants and/or trees and/or stumps and more particularly liquid chemical products usable at this ends. The invention also relates to a brush cutter provided with such a device. The use of a device and a brush cutter by a same user allow a substantial improvement in the efficiency of workers.

### DESCRIPTION OF THE PRIOR ART

It is known in the art to use sprayers to applied sprays of treatments fluids to plants and/or trees and/or stumps of trees. Such sprayers are well known and some are wearable by the user Said sprayers may be divided into several classes including those of the type provided with a pressurized tank and those of the type provided with a reservoir having pumping means. It is also known in the art to associate pressurized or gravitational sprayers with brush cutter for punctual treatment of stumps.

However, existing devices or brush cutters provided with such devices are either heavy due to the pressurized tank or inefficient. Furthermore, existing devices show leaks problems (i.e. dripping of fluids at the nozzle) or necessitate the operation of a trigger valve to activate spraying of fluid at the nozzle. Leaks problems are important when the device is mounted on a brush cutter because vibrations of said cutter in use. Weight problems associated with combination of brush cutters and spraying device involve that workers are bothered in their movements and this may lead to a substantial increase of risks of accidents and possible damage to the environment (example: accidental release or dripping of phytocides).

The applicant has now discovered that it is possible to make light the spraying device that is substantially leak proof even when subjected to high vibrations. Advantageously, the problem of leaks of treatment fluids may be solved with an original valve that is opened only when the pumping means is started and prevent fluid leaks when the pumping means is stopped.

Advantageously, the device according to the invention may comprise a reservoir made of synthetic material, such as plastic material, and pumping means in fluid communication with said reservoir. Preferably, the device may be worn on the back of the user. Pumping means are preferably a mini-pump operated by a small electric motor (e.g. a direct current electric motor). More preferably, the pumping means may be a small submersible pump operated by a DC electric motor that is sealed into a plastic capsule to work in the fluid. According to the invention there is no need to pressurize the reservoir.

### SUMMARY OF THE INVENTION

More particularly the present invention relates to a device for spraying a fluid, said device comprising:

a reservoir for the fluid to be sprayed;

pumping means comprising a electric motor operated pump having an inlet port in fluid communication with the fluid of said reservoir and an outlet port;

a tubing having opposite ends, one end being in fluid communication with the outlet port of the pump, the other end being in fluid communication with a spraying nozzle;

electric power supply means;

switch means, especially a on-off switch means;

electrical wiring connecting the electric power supply means, the electric motor and the switch means to have the electric motor remotely operated by said switch;

a harness means allowing a user to wear an assembly defined by the reservoir, the pumping means and the power supply means; and

a valve means provided across the tubing to allow passage of said fluid when this latter is pressurized by the pump and to prevent said fluid to drip from the nozzle when not pressurized by the pump.

Advantageously, a first fixing means is provided for fixing the nozzle and at least a portion of the tubing to a frame of a brush cutter of the type further comprising a working head, a motor, handles and a driving shaft connecting said motor to the working head, said portion of tubing being fixed to said frame to have said nozzle positioned in the vicinity of said working head; and wherein a second fixing means is provided for fixing the switch to a handle of said brush cutter.

Advantageously, the valve means comprises

a sleeve having opposite ends, an inner surface and an outer surface;

a ball;

a spring, preferably a compression spring, having opposite ends;

a first tubular member having opposite ends, one end thereof being provided with a vibration absorbing material and defining a seat for the ball while the opposite end is provided with means for engagement with one end of the spring;

a second tubular member having opposite ends, one end thereof being provided with an outer surface that contacts the inner face of the sleeve, while the opposite end is provided with means for engagement with the other end of the spring;

a third tubular member having opposite ends and an outer surface, one end of said third tubular member defining a seat for the ball; and

a sealing means contacting the outer surface of the third member and the inner surface of the sleeve, said sealing means further having vibration absorbing properties;

the third tubular member being at such a distance from the first tubular member that the spring pushes the ball against the seat of the third tubular member, said ball and the second tubular member being movable between two extreme positions, one with the ball pressed by the spring against both ball seats and to prevent the fluid to flow through said valve and prevent possible dripping of the fluid at the nozzle (when the pumping means are stopped) and another position with the ball held away the ball seat of the third tubular member under the action of the fluid pressurized by the pumping means to have the fluid flowing under pressure through the valve toward the nozzle. Of course, the sleeve has an inlet end and an outlet end. The inlet end is oriented toward the pumping means while the outlet end is oriented toward the nozzle.

Advantageously, the valve means is further mounted across the hose that is in fluid communication with the outlet port of the pump and the nozzle. Preferably, the sleeve may be completely inserted within the hose. In this case, the outer surface of the sleeve engages (by friction) the inner surface of the tubing. This frictional engagement is sufficient to held the valve in place in the tubing. Alternatively, the hose may be cut in two parts and the sleeve may be inserted in each ends to connect the hose parts together.

Advantageously, the sleeve may be made of a rigid plastic material; the seal may be made of a rubber like material, the ball and the tubular members may be made of plastic material. Of course, any appropriate material may be used. A particularly preferred material may be polypropylene. Preferably, it is resistant to fluids commonly used for the treatment of plants, trees and stumps. Alternatively, the valve means may be made of stainless steel. The spring is preferably made of stainless steel. However, any other appropriate material can be used.

Advantageously, the tubing is made of a first section and a second section, one end of the first section being connected to one end of the second section by a conventional hose connector; and the electrical wiring is provided with an electrical connector to allow the user to reversibly separate the assembly defined by the reservoir, the pumping means and the supply means from the brush cutter. Alternatively, the electrical connection may male an integral part of the hose connection.

Advantageously, the conventional hose connector is a conventional two parts quick plug for pressurized hoses; and the conventional wires connector is a conventional two parts electrical plug. Preferably, the two parts quick plug may be the one made of nylon and sold by the company MERCURY®.

Advantageously, the inlet port of said pump may be positioned inside the reservoir. Preferably, said pump may be an electric motor operated submersible pump.

Advantageously, the harness means comprise a conventional backpack, the reservoir being housed within a main pouch of said backpack; and wherein an opening is provided in said pouch to allow the passage of the tubing and electrical wiring.

The invention also relates to a brush cutter of the type comprising a frame provided with a working head, a motor, handles and a driving shaft connecting said motor to the working head, wherein a portion of the tubing of a device as defined hereinbefore is fixed to said frame with fastening means to have the nozzle positioned in the vicinity of said working bead; and a switch, preferably an on-off switch, is fixed to a handle of said brush cutter with fastening means preferably to make easily reachable said switch by the user wearing a harness to which is attached the remain of the device.

Advantageously, the fastening means are conventional mechanical clips or fasteners. Of course, any conventional clips or fasteners may be used.

### BRIEF DESCRIPTION OF THE DRAWINGS

Particularly preferred embodiments of the invention will be described hereinafter with reference to the following drawings:

FIG. 1 is a rear perspective view of the device according to the invention with the hose connected to a spraying tubular wand provided with a spray nozzle.

FIG. 2 is a rear perspective view of a brush cutter and a device where the spraying tubular wand is mounted on the frame, an on-off switch is mounted to one handle of said brush cutter; and connectors are provided for electric wiring and hose.

FIG. 3 is a partial cross sectional view of the tube with the male portion of a conventional quick plug for pressurized hose.

FIG. 4 is a cross sectional view of the valve of FIG. 3 according to IV-IV, in closed position.

FIG. 5 is a cross sectional view of the valve according to the invention in opened position. Represented is an optional mounting of the valve in the hose 15

FIG. 6 is a rear view of the reservoir.

FIG. 7 is a cross sectional view of the reservoir.

FIG. 8 is a partial perspective view showing the connection of the hose to a tubular wand.

FIG. 9 is a cross sectional view of the connection illustrated in FIG. 8.

FIG. 10 is a partial view of a handle of the brush cutter equipped with a on-off switch.

### DETAILED DESCRIPTION OF PARTICULARLY PREFERRED EMBODIMENTS

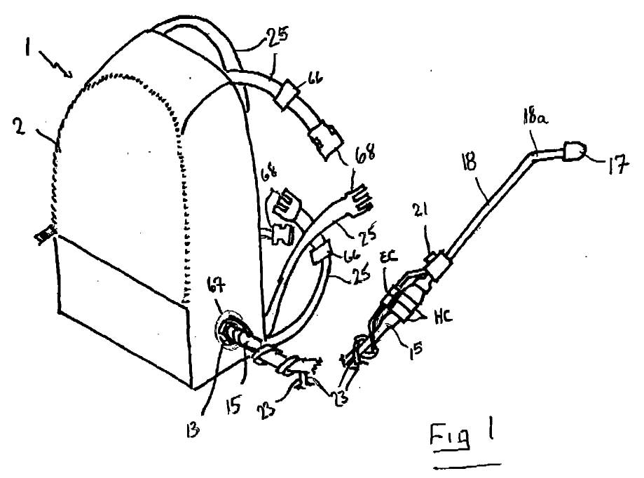

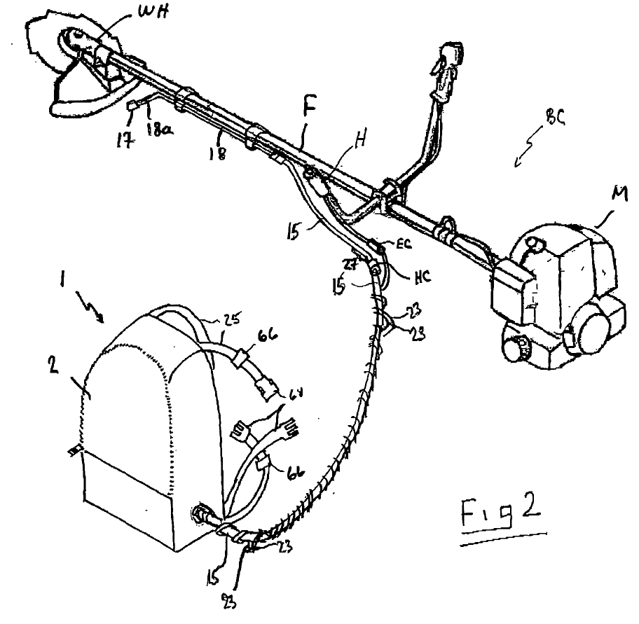

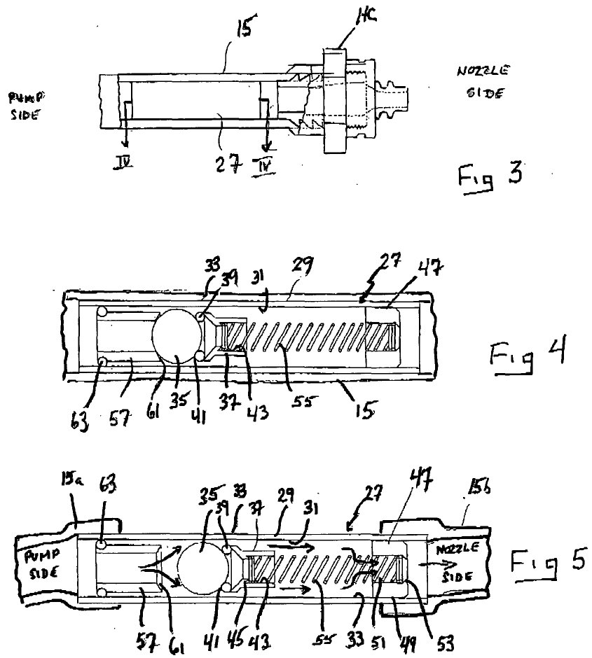

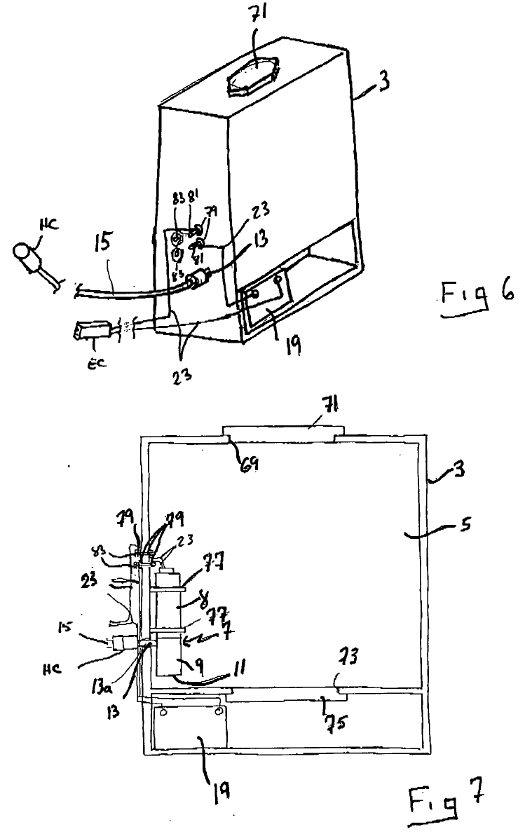

As illustrated in FIGS. 1, 2, 6 and 7, the spraying device 1 comprises:

a packsack 2;

a reservoir 3 provided with a capacity 5 for the fluid to be sprayed;

pumping means 7 comprising a electric motor 8 operating a pump 9 having an inlet port 11 in fluid communication with the fluid of said reservoir 3 and an outlet port 13;

a tubing 15 having opposite ends, one end being in fluid communication with the outlet port 13 of the pump, the other end being in fluid communication with a spraying nozzle 17;

electric power supply means 19;

a on-off switch means 21;

electrical wiring 23 connecting the electric power supply means 19, the electric motor 8 and the on-off switch means 23 to have the electric motor 8 remotely operated by the on-off switch 23;

a harness means 25 allowing a user to wear an assembly defined by the reservoir 3, the pumping means 7 and the power supply means 19; and

a valve means 27 which is provided across the tubing 15 between the outlet port 13 of the pump 9 and the spraying nozzle 17 to allow passage of said fluid when pressurized by the pump 9 and prevent the fluid to drip off the nozzle 17 when not pressurized by the pump 9. Preferably, the nozzle 17 may be mounted on a tubular wand 18 that is advantageously provided with a bent portion 18a.

Preferably, a first fixing means 100 is provided for fixing the nozzle and at least a portion of the tubing to a frame F of a cutter BC of the type farther comprising a working head WH, a motor M, handles H and a driving shaft DS connecting said motor to the working head, said portion of tubing being fixed to said frame to have saif nozzle 17 positioned in the vicinity of said working head WH; and wherein a second fixing means 110 is provided for fixing the on-off switch to a handle H of said brush cutter BC. The invention also relates to the particularly preferred combination.

More particularly, the valve means 27 comprises

a sleeve 29 having opposite ends, an inner surface 31 and an outer surface 33;

a ball 35;

a first tubular member 37 having opposite ends, one end thereof being provided with a vibration absorbing material 39 (preferably a “O” ring made of an elastomeric material such as a synthetic or natural rubber) and defining a seat 41 for the ball 35 while the opposite end defines a housing 43 provided with at least one inwardly projecting stopper 45;

a second tubular member 47 having opposite ends, one end thereof being provided with an outer surface 49 that contacts the inner face 31 of the sleeve 29, while the opposite defines a housing 51 provided with at least one inwardly projecting stopper 53;

a compression spring 55 having opposite ends, one end contacting the stopper 45 of the first tubular member 37 while the opposite end contacts the stopper 53 of the second tubular member 47,

a third tubular member 57 having opposite ends and an outer surface 59, one end of said third tubular member 57 defining a seat 61 for the ball 35; and

a sealing means 63 contacting the outer surface 59 of the third member 57 and the inner surface 31 of the sleeve 29, said sealing means 63 further having vibration absorbing properties (preferably a “O” ring made of an elastomeric material such as a synthetic or natural rubber);

the third tubular member 57 being at such a distance from the first tubular member 37 that the spring 55 pushes the ball 35 against the seat 61 of the third tubular member 57, said ball 35 and the second tubular member 45 being movable between two extreme positions, one with the ball 35 pressed by the spring 55 against both ball seats 41, 61 to prevent the fluid to flow through said valve and to prevent dripping of the fluid at the nozzle 17 (when the pumping means are stopped) and another position with the ball 35 held away from the scat 61 of the third tubular member under the action of the fluid pressurized by the pumping means to have the fluid flowing under pressure through the valve toward the nozzle 17. Advantageously, the fluid follows the arrows illustrated in FIG. 5. More particularly, the reservoir and the constitutive parts of the device are made of plastic material that are resistant to liquid chemical products generally used in the treatment of plants, trees and/or stumps, such as phytocides, herbicides and all other similar products, especially those having a small viscosity. Preferred plastic material may be polypropylene. Alternatively, plastic material may be replaced by any other appropriate material such as stainless steel.

According to a particularly preferred embodiment, the reservoir may have a capacity of 4,5 litres, the harness means may be defined, as illustrated in FIG. 1, by a conventional backpack 2 provided with an usual main pouch, straps and belts to be comfortably wear on the back of a user. A small opening 67 may be provided on the side of the backpack to allow passage of tubing 15 and wires 23. Advantageously, the backpack is made with a fabric that is water resistant and of course weather resistant. Preferably, said backpack 2 may have adjustable straps provided with adjustment buckles 66 and fasteners 68 (well known in the field of backpacks). Characteristics of the straps, adjustment buckles and fasteners are well known and do not necessitate any detailed description.

According to a particularly preferred embodiment of the invention, the power supply 19 means is portable and may consist of dry cells, especially rechargeable dry cells. Advantageously, a rechargeable 12 volts dry cell may be used. Preferably the cell may be recharged up to 500 times and have a weight of about 4.20 pounds.

Advantageously, the tubing 15 is made of a first section 15a and a second section 15b, one end of the first section being connected to one end of the second section by a conventional hose connector HC; and the electrical wiring is provided with an electrical connector EC to allow user to reversibly separate the assembly defined by the reservoir, the pumping means and the supply means from the brush cutter BC. Advantageously, the conventional hose connector is a conventional two parts quick plug for pressurized hoses; and the conventional wires connector is a conventional two parts electrical plug. Optionally, filtering means FT may be provided.

Optionally, a fuse may be provided across the electric circuit to protect the motor. Advantageously, the wiring may comprise at least two electric wires and optionally three electric wires.

Optionally, as illustrated in the drawings, the reservoir may be provided with a first opening 69 for filling the reservoir 3. This opening 69 may be closable by a cork 71. Preferably, the cork 71 may be provided with thread engaging corresponding thread in the opening to have the cork 71 reversibly screwed in the opening 69. Advantageously, the opening 69 and the cork 71 have a 4 inches diameter.

Optionally, as illustrated in the drawings, the reservoir may be provided with a second opening 73 for allowing to empty the reservoir 3. This opening 73 may be closable by a cork 75. Preferably, the cork 73 may be provided with thread engaging corresponding thread in the opening to have the cork 75 reversibly screwed in the opening 73. Advantageously, the opening 73 and the cork 75 have a 4 inches diameter.

Preferably, the pumping means comprise a sealed electric motor 8 connected to a submersible pump 9 having an inlet port 11 and an outlet port 13, the outlet port 13 being in fluid communication with a tubing 13a passing through the wall of the reservoir 3 and having a free end provided with the female part of a two part quick plug for pressurized hoses. The tubing 13a may be soldered to the wall of the reservoir 3. Alternatively, any appropriate sealing means (e.g. a sealant) may be used to prevent fluid leaks. The female part of said quick plug is generally provided with a check valve means preventing drainage of the content of the reservoir when the male part is not engaged therein. Those quick plug are well known in the art and do not need any extensive description. Alternatively, the outlet port may consist of a 7 mm tubing on which the 8 mm tubing is coaxially mounted. Frictional engagement between saids 7 mm and 8 mm tubings is sufficient to make a tight and solid connection.

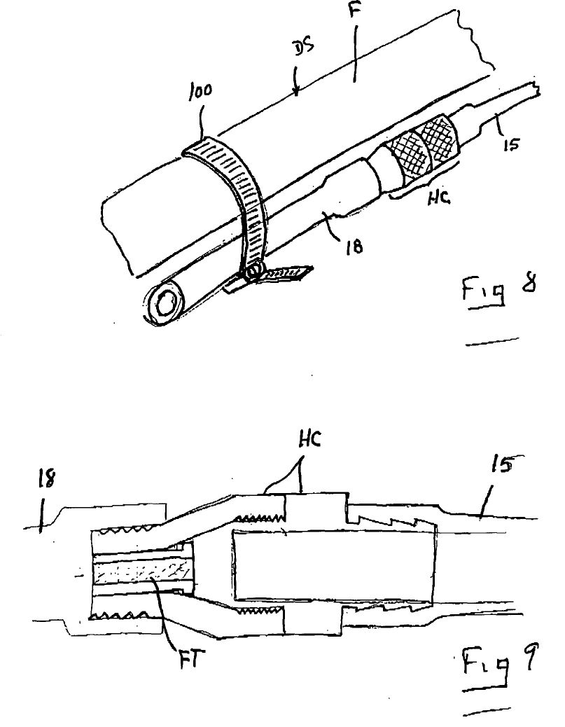

The pumping means and electric motor, as illustrated in FIG. 7, are held in place within the reservoir by a pair of support members 77. Preferably, one of said support members 77 are respectively positioned at 1.25 inch and 2.5 inches from the bottom of the reservoir and the outlet port of the pump is positioned at 1 inch of the bottom of the reservoir. Preferably, the inlet port of the pump may be optionally provided with filtering means (not illustrated). The electric motor is preferably encapsulated in a water tight hard shell made of plastic material to allow it use within the fluid.

Neoprene washers 79 allows the wires to pass through the wall of the reservoir 3. More particularly, for each wire a bolt 81 pass through the wall. An electric wire is connected on both side of the wall and then held in place by a nut 83. Washers 79 may be positioned against both sides of the wall.

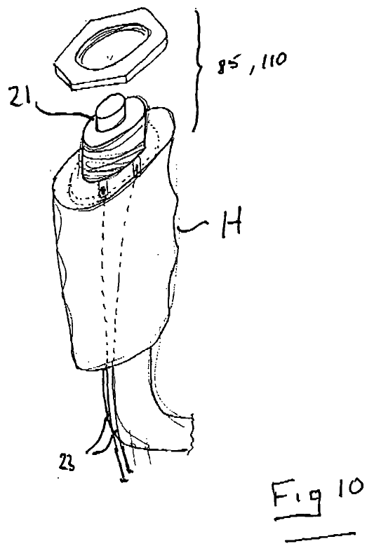

Preferably, the electric wires comprise two wires, a negative and a positive. They follow the side of the reservoir; the positive wire connects the motor 8 and the cell 19. Two negative wires respectively connect the cell 19 and the on-off switch 21 and the electric motor 8 and the on-off switch 21. The on-off switch 21 may be of any appropriate kind, including the trigger type or press button type. Preferably, the on-off switch is of the press button type. More particularly, as illustrated in FIG. 9, the on-off switch is mounted by means of nut-bolt assembly 85 cooperating with the handle H of the brush cutter BC. Any other appropriate on-off switch may be fastened to the handle of the brush cutter by any appropriate means such as mechanical clips, tie-wrap, etc.

Alternatively, the cell 19 may be worn by the user thanks to a harness including a belt of the user or including a specific belt wear at the waist of the user.

Advantageously, the tubing 15 may be made of flexible material, especially a 8 mm diameter flexible plastic tubing.

Advantageously, the nozzle is of the type well known in the art, especially a nozzle of Chapin type that may be screwed at one end of a tubular wand 18 (rigid tubular conduit having a portion 18a that is angularly bent). Such wand and nozzle are well known in the art and do no need any detailed description. Preferably, the nozzle 17 may be made of brass.

In use, when the device 1 has a part thereof mounted on the frame of the brush cutter BC, the user may spray a treatment liquid on a punctual area to be treated (example a stumps of brushes he just finished to cut) by mere pressure of the press button with the thumb of his hand on the left handle of the brush cutter. When he press said button, the pump 9 is activated by the motor 8 and the pressure generated moves the ball 35 away from the seat 61 and allow the fluid to flow through said valve and then sprayed while exiting the nozzle 17. When he release the button, the pump stops and the spring 45 returns the ball against the seat 61 to prevent the fluid to pass the valve and prevent the fluid to drip from the nozzle 17. When the user wants to leave, he may disconnect the hose connector HC and the electric connector EC and leave the brush cutter BC on the premise. Later, he can reconnect said connectors and continue his work.

Of course, the above description of the embodiments of the invention is not limitative and also comprises all possible variations and embodiments that may seems obvious to a man skilled in the art.

What is claimed is:

1. A device for spraying a fluid, said device comprising:
a reservoir for the fluid to be sprayed;
pumping means comprising a electric motor operated pump having an inlet port in fluid communication with the fluid of said reservoir and an outlet port;
a tubing having opposite ends, one end being in fluid communication with the outlet port of the pump, the other end being in fluid communication with a spraying nozzle;
electric power supply means;
a switch means;
electrical wiring connecting the electric power supply means, the electric motor and the switch means to have the electric motor remotely operated by the switch;
a harness means allowing a user to wear an assembly defined by the reservoir, the pumping means and the power supply means; and
a valve means provided across the tubing to allow passage of said fluid when this latter is pressurized by the pump and to prevent said fluid to drip from the nozzle when not pressurized by the pump.

2. A device according to claim 1, wherein a first fixing means is provided for fixing the nozzle and at least a portion of the tubing to a frame of a brush cutter of the type further comprising a working head, a motor, handles and a driving shaft connecting said motor to the working head, said portion of tubing being fixed to said frame to have said nozzle positioned in the vicinity of said working head; and wherein a second fixing means is provided for fixing the on-off switch to a handle of said brush cutter.

3. A device according to claim 1, wherein the valve means comprises
a sleeve having opposite ends, an inner surface and an outer surface;
a ball;
a spring having opposite ends;
a first tubular member having opposite ends, one end thereof being provided with a vibration absorbing material and defining a seat for the ball while the opposite end is provided with means for engagement with one end of the spring;
a second tubular member having opposite ends, one end thereof being provided with an outer surface that contacts the inner face of the sleeve, while the opposite end is provided with means for engagement with the other end of the spring;
a third tubular member having opposite ends and an outer surface, one end of said third tubular member defining a seat for the ball; and
a sealing means contacting the outer surface of the third member and the inner surface of the sleeve, said sealing means further having vibration absorbing properties;
the third tubular member being at such a distance from the first tubular member that the spring pushes the ball against the seat of the third tubular member, said ball and the second tubular member being movable between two extreme positions, one with the ball pressed by the spring against both ball seats and to prevent the fluid to flow through said valve and prevent possible dripping of the fluid at the nozzle (when the pumping means are stopped) and another position with the ball held away the ball seat of the third tubular member under the action of the fluid pressurized by the pumping means to have the fluid flowing under pressure through the valve toward the nozzle.

4. A device according to claim 3, wherein the spring is a compression spring and wherein means for engagement with ends of the compression spring comprise a flange projecting from the first tubular member and a flange projecting from the second tubular member.

5. A device according to claim 4, wherein the sleeve is made of a rigid plastic material; the seal are made of a rubber like material, and the ball and the tubular members are made of plastic material.

6. A device according to claim 4, wherein the switch is an on-off switch, wherein the tubing comprises a first section and a second section, one end of the first section being connected to one end of the second section by a conventional hose connector; and the electrical wiring extending between the device and the brush cutter is provided with an electrical connector; to allow the user to reversibly separate the assembly defined by the reservoir, the pumping means and the power supply means from the brush cutter.

7. A device according to claim 5, wherein the conventional hose connector is a conventional two parts quick plug for pressurized hoses; and the conventional wires connector is a conventional two parts electrical plug.

8. A device according to claim 7, wherein said pump is an electric motor operated submersible pump positioned inside the reservoir.

9. A device according to claim 8, wherein the harness means comprise a conventional backpack, the reservoir being housed within a main pouch of said backpack; and wherein an opening is further provided in said pouch to allow the passage of the tubing and electrical wiring.

10. A brush cutter of the type comprising a frame provided with a working head, a motor, handles and a driving shaft connecting said motor to the working head, wherein a portion of the tubing of a device as defined in claim 1 is fixed to said frame with fastening means to have the nozzle positioned in the vicinity of said working head; and a switch is fixed to a handle of said brush cutter with fastening means.

11. A brush cutter according to claim 10, wherein fastening means are conventional mechanical clips or fasteners.

12. A brush cutter according to claim 11, wherein the switch is an on-off switch, wherein the tubing comprises a first section and a second section, one end of the first section being connected to one end of the second section by a conventional hose connector; and the electrical wiring extending between the device and the brush cutter is provided with a conventional electrical connector; to allow the user to reversibly separate the reservoir—pumping means—power supply assembly from the brush cutter.

13. A brush cutter according to claim 12, wherein the conventional hose connector is a conventional two parts quick plug for pressurized hoses; and the conventional wires connector is a conventional two parts electrical plug.

14. A brush cutter according to claim 12, wherein said pump is an electric motor operated submersible pump positioned inside the reservoir.

15. A brush cutter according to claim 14, wherein the harness means comprise a conventional backpack, the reservoir being housed within a main pouch of said backpack; and wherein an opening is further provided in said pouch to allow the passage of the tubing and electrical wiring.

16. A brush cutter according to claim 11, wherein the valve means comprises:
a sleeve having opposite ends, an inner surface and an outer surface;
a ball;
a spring having opposite ends;
a first tubular member having opposite ends, one end thereof being provided with a vibration absorbing material and defining a seat for the ball while the opposite end is provided with means for engagement with one end of the spring;
a second tubular member having opposite ends, one end thereof being provided with an outer surface that contacts the inner face of the sleeve, while the opposite end is provided with means for engagement with the other end of the spring;
a third tubular member having opposite ends and an outer surface, one end of said third tubular member defining a seat for the ball; and
a scaling means contacting the outer surface of the third member and the inner surface of the sleeve, said sealing means further having vibration absorbing properties;
the third tubular member being at such a distance from the first tubular member that the spring pushes the ball against the seat of the third tubular member, said ball and the second tubular member being movable between two extreme positions, one with the ball pressed by the spring against both ball seats and to prevent the fluid to flow through said valve and prevent possible dripping of the fluid at the nozzle (when the pumping means are stopped) and another position with the ball held away the ball seat of the third tubular member under the action of the fluid pressurized by the pumping means to have the fluid flowing under pressure through the valve toward the nozzle.

17. A brush cutter according to claim 16, wherein the sleeve is made of a rigid plastic material; the seal are made of a rubber like material, and the ball and the tubular members are made of plastic material.

18. A brush cutter according to claim 16, wherein fastening means are conventional mechanical clips or fasteners.

19. A brush cutter according to claim 16, wherein the switch is an on-off switch, wherein the tubing comprises a first section and a second section, one end of the first section being connected to one end of the second section by a conventional hose connector; and the electrical wiring extending between the device and the brush cutter is provided with a conventional electrical connector; to allow the user to reversibly separate the reservoir—pumping means—power supply assembly from the brush cutter.

20. A brush cutter according to claim 19, wherein the conventional hose connector is a conventional two parts quick plug for pressurized hoses; and the conventional wires connector is a conventional two parts electrical plug.

21. A brush cutter according to claim 20, wherein said pump is an electric motor operated submersible pump positioned inside the reservoir.

22. A brush cutter according to claim 16, wherein the harness means comprise a conventional backpack, the reservoir being housed within a main pouch of said backpack; and wherein an opening is further provided in said pouch to allow the passage of the tubing and electrical wiring.
